(19) United States
(12) Patent Application Publication
(10) Pub. No.: US 2012/0265476 A1
(43) Pub. Date: Oct. 18, 2012

(54) System Test Specification Generation Device and Testing Device

(75) Inventors: Kentaro Yoshimura, Hitachi (JP); Fumio Narisawa, Hitachinaka (JP); Yuichiro Morita, Hitachi (JP)

(73) Assignee: Hitachi, Ltd., Chiyoda-ku, Tokyo (JP)

(21) Appl. No.: 13/513,070

(22) PCT Filed: Nov. 25, 2010
(86) PCT No.: PCT/JP2010/006873

§ 371 Date: Jul. 3, 2012

(30) Foreign Application Priority Data
Dec. 3, 2009 (JP) 2009-275017

(51) Int. Cl. G06F 19/00

(52) U.S. Cl. 702/123

(57) ABSTRACT

Disclosed is a system test specification generation device for generating a system test specification to be applied to software comprising a plurality of software components in a state in which the software components have been combined.

The system test specification generation device comprises software 1, a specification analysis unit 2, a system test specification database 3, a system test specification setting unit 4, and a system test specification output unit 5. The software 1 comprises software components 11, 12, and 13. The specification analysis unit 2 comprises software component specification extraction units 21, 22, and 23 corresponding to each software component and a system specification integration unit for integrating software component specifications to generate a system specification. The system specification setting unit 4, on the basis of a system specification from the system specification integration unit 24, reuses a system test specification stored in the system test specification database 3, generates a system test specification to be applied with the software components combined, and outputs it to the system test specification output unit 5.

### TECHNICAL FIELD

The present invention relates generally to software test specification generation devices, and more specifically to a system test specification generation device which generates a system test specification used for testing whether software comprising a plurality of software components satisfies a functional specification for a system or not and a testing device for testing the software built in a real machine using the generated test specification.

### BACKGROUND ART

In software technology, there is well known built-in software which is built in equipment such as automobiles and cell phones to control them. Such built-in software has advantages capable of realizing more flexible and advanced control compared to control systems utilizing conventional mechanical mechanisms and electric circuits, and capable of developing many derivative products by giving partial changes to the software.

Regarding software test specification generation devices, Patent Literature 1 discloses, as a software test specification generation device, a technique for newly generating a test specification for a specific product of software by describing the functional specification of software to be analyzed in a tabular form.

Also, Patent Literature 2 discloses, as a test specification generation device for reusable software components, a technique for generating a test specification for a specific machine by preparing a standard test specification for each software component and customizing the standard test specification on the basis of setting information of the software component when used for a product.

### CITATION LIST

### Patent Literature

[PTL 1] Japanese Patent Laid-open No. Hei 11 (1999)-306046
[PTL 2] Japanese Patent Laid-open No. 2005-250590

### SUMMARY OF INVENTION

### Technical Problem

However, in the test specification generation device of Patent Literature 1, there is a need to thoroughly review a newly-generated test specification to validate the test specification itself. On the other hand, the technique of Patent Literature 2 although allows to reuse the standard test specification for each software component, in the case of software comprising a plurality of software components, there is a need to develop a system test for software on a product-by-product basis.

An example of software can be found in automobile engine control systems. Regarding automobile engines, there are many product specifications to meet mechanical requirements such as the number of cylinders, piston displacements, fuel injection systems, and air intake control systems, and requirements such as destinations and relevant emission control regulations. Also, there are multiple choices with respect to the respective product specification of software, e.g., four cylinders, six cylinders, and eight cylinders as to the number of cylinders. In automobile engine control systems, software components are provided so as to meet each product specification, especially, so-called reusable software component-based development becomes predominant. In the reusable software component-based development, software components are provided for each product specification, and the provided software components are combined to construct entire software.

Conventionally, software has been developed for each target product or partially has been developed in accordance with a difference between a target product and a similar existing. However, improvement in development efficiency for software is required with increase in the number of derivative products and the scale of software as the application of built-in software has expanded. In particular, there is a need to improve the efficiency of reusable software component-based development in derivative product. The software development process can be largely categorized into a requirement analysis process, a design process, a mounting process, and a validation process. The present invention relates to improving the efficiency of the validation process, in particular.

In such reusable software component-based development, required is a system test specification used for verifying whether the system comprising combined software components operates as desired. In particular, in order to guarantee the validity of the system test specification, it is desirable that the system test specification with a proven record with a past product be reused.

In light of the foregoing, it is an object of the present invention to provide a system test specification generation device which generates a system test specification by integrating information on reusable software components to associate it with a component-based system test specification, thereby improving productivity in software validation, and a testing device utilizing the system test specification.

### Solution to Problem

In accordance with a first aspect of the present invention, a system test specification generation device generates a system test specification for verifying the operation of software which is built in equipment having a sensor and an actuator and operates on the basis of the functional specification of the software, the software comprising a plurality of software components. The system test specification generation device comprises: a specification information analysis unit comprising a plurality of software component specification extraction units for extracting software component specification information, corresponding to each of the software components, and a system specification integration unit for integrating the software component specification information to generate a system specification; a system test specification database for storing a reusable system test specification for the software; a system test specification setting unit for constructing a system test specification from the system test specification database on the basis of the system specification; and a system test specification output unit for outputting the system test specification.

The software component specification extraction units extract at least software component-specific information for identifying the software components and software component parameter setting information of software component parameters for setting the software components for a specific product.

The system specification integration unit has a system specification converter for associating at least either the software component-specific information or the software component parameters with a system specification.

The system test specification stored in the system test specification database comprises a plurality of system test specification components for defining a test pattern and a system test specification framework for defining the execution timing of the system test specification components.

The system test specification components comprise a system test specification input component to be an input to the software and a system test specification assessment component to be a reference output of the software.

The system test specification setting unit changes the system test specification components to be executed from the system test specification framework in accordance with the system specification.

The system test specification setting unit changes parameters of the system test specification components in accordance with the system specification.

The system test specification stored in the system test specification database is input/output device operation patterns of the equipment.

The software, which is built-in software that operates built in equipment, is particularly basic software for operating input/output devices of the equipment. The system test specification stored in the system test specification database is a combination of the input/output device operation patterns of the equipment and a sample application for executing the basic software.

Also, in another aspect of the present invention, a device comprises an electronic control unit having software embedded therein and a real-time testing device where a system test specification is executed. The device performs an operation test by giving the generated system test specification to the electronic control unit. The electronic control unit comprises built-in software to be tested and a CPU to which external input/output terminals are connected, the CPU executing the built-in software. The real-time testing device comprises the system test specification database according to the first aspect. As the system test framework is executed, the real-time testing device computes a test input pattern from a system specification input component and gives the input pattern to the electronic control unit as inputs such as voltage and current. The built-in software of the electronic control unit performs computations on the basis of the input pattern and generates an output signal. The system test framework of the real-time testing device executes the system test specification assessment component to compute a test output pattern in predetermined timing and compares it with the output signal of the electronic control unit to determine whether the output signal is within a predetermined margin of error or not, thereby testing whether the built-in software is functioning as required.

### Advantageous Effects of Invention

According to the present invention, a system test specification to be applied to newly developed software can be generated on the basis of reusable software components and the setting information of the software components. This makes it possible to improve productivity in software validation.

### BRIEF DESCRIPTION OF DRAWINGS

FIG. 1 is a block diagram of a system test specification generation device in accordance with an embodiment of the present invention.

FIG. 2 is a block diagram of software for engine control.

FIG. 3 is an illustration showing setting parameters of a software component.

FIG. 4 is an illustration showing a correspondence between a software component specification and a system specification.

FIG. 5 is a block diagram of a system test specification database.

FIG. 6 shows attributes of system test components.

FIG. 7 is an illustration showing a correspondence between a system specification and system test component A.

FIG. 8 shows a waveform pattern of system test component A1.

FIG. 9 shows a waveform pattern of system test component A2.

FIG. 10 shows a waveform pattern of system test component A3.

FIG. 11 shows a parameter setting unit concerning system test component A of a system test specification setting unit.

FIG. 12 shows a correspondence between a system specification and system test component B.

FIG. 13 shows a correspondence between a system specification and system test component C.

FIG. 14 shows a system test specification. It shows input waveforms of test component A2, test component B, and test component C2 and an output waveform (reference output) of test component D1.

FIG. 15 is a block diagram of a testing device, showing a test environment of built-in software in which a system test specification is used.

### DESCRIPTION OF EMBODIMENTS

A system test specification generation device in accordance with an embodiment of the present invention will be described in detail hereinafter with reference to the accompanying drawings.

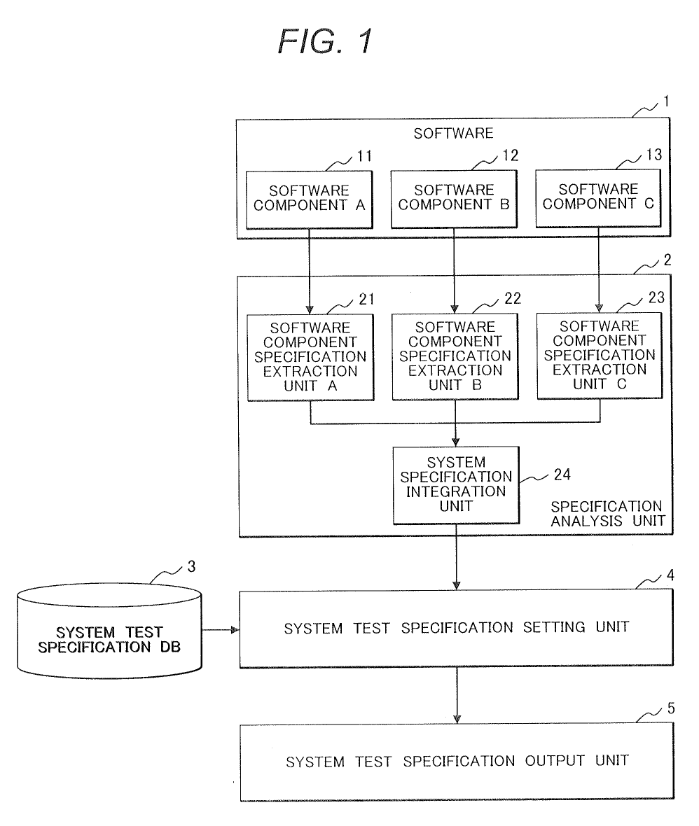

FIG. 1 is a block diagram showing an outline of a system test specification generation device in accordance with an embodiment of the present invention. The system test specification generation device generates a system test specification for doing a verification operation of software which operates in a state of being built in equipment having a sensor and an actuator, on the basis of functional specification of the software.

The system test specification generation device comprises software 1 to be tested, a specification analysis unit 2 for analyzing a software specification, a system test specification database 3 for storing a reusable system test specification for the software 1 to be tested, a system test specification setting unit 4 for setting a system test specification on the basis of the software specification of interest from the system analysis unit 2 and the system test specification database 3, and a system test specification output unit 5 for outputting the system test specification to an external storage or a test environment.

The software 1 comprises a plurality of built-in software components: software component A 11, software component B 12, and software component C 13.

The specification analysis unit 2 is comprised of: software component specification extraction units 21, 22, and 23 provided so as to correspond to the plurality of software components 11, 12, and 13 constituting the software 1 to extract specifications of the software components respectively; and a system specification integration unit 24 for integrating the software component specifications of the plurality of software components 11, 12, and 13 and converting them into a system specification.

The structure as described above can integrates specifications of the plurality of software components constituting the software into a system specification for entire software and reuse of a system test specification from the system specification data base in accordance with this system specification.

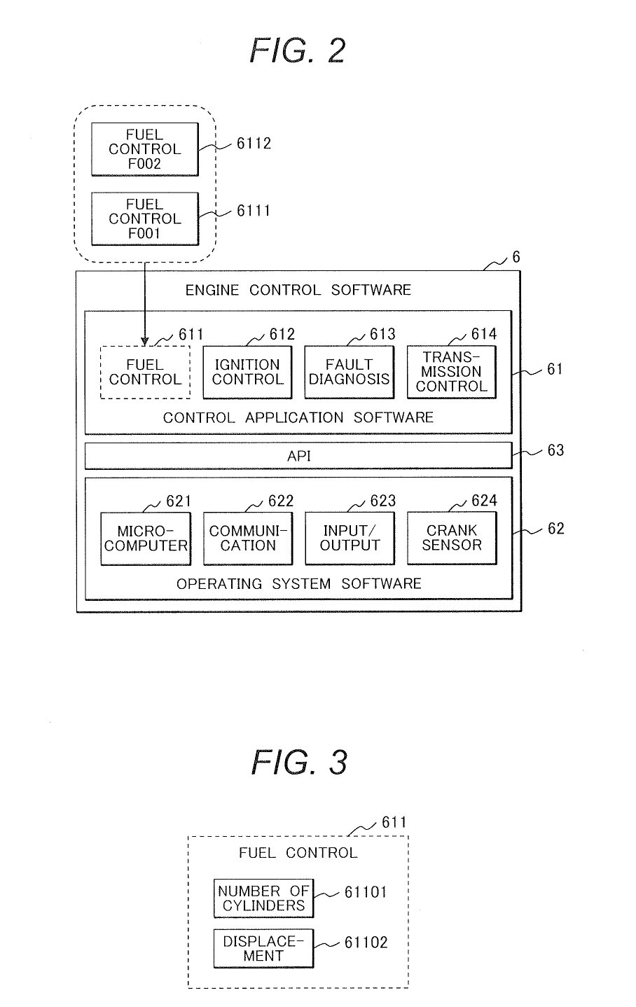

FIG. 2 is a block diagram of automobile engine control software 6 as a concrete example of the software 1 to which the system test specification generation device is applied. The engine control software 6 comprises control application software 61, basic software 62, and an application program interface (API) 63. The control application software 61 comprises a fuel control software component 611, an ignition control software component 612, a fault diagnosis software component 613, and a transmission control software component 614. The basic software 62 comprises a microcomputer software component 621, a communication software component 622, an input/output software component 623, and a crank sensor software component 624.

Herein, first of all, described is done about a case where a new product of software is developed using the structure of the engine control software 6. The fuel control software component 611 has its variations: a fuel control software component 6111 and a fuel control software component 6112, each having its specific identifying information (ID) F001 and F002, respectively. At the time of development of the new product, either fuel software component 6111 or fuel software component 6112 is selected on the basis of a system specification and a control specification which are specific to the product to constitute the engine control software 6.

Each software component specification extraction unit (e.g. 21) extracts, as a specification of a software component, a software component ID as information as to which variation of software components has been mounted. The software component specification extraction unit 21 extracts software component-specific information (ID) and setting parameters. The software component-specific ID is to identify a software component. The setting parameters are pieces of software component parameter setting information for setting the software component for a specific product of software.

FIG. 3 is an illustration showing the number of cylinders 61101 and displacement 61102 which are common setting parameters for the fuel control software component in the engine control software 6 in the present embodiment. As shown in FIG. 2, the fuel control software component 611 has its variations: the fuel control software component 6111 and the fuel control software component 6112. The two have the number of cylinders 61101 and displacement 61102 in common as setting parameters for the system (engine) to be controlled by the software.

The software component specification extraction unit 21 extracts the setting parameters of the software component as the specification of the software component.

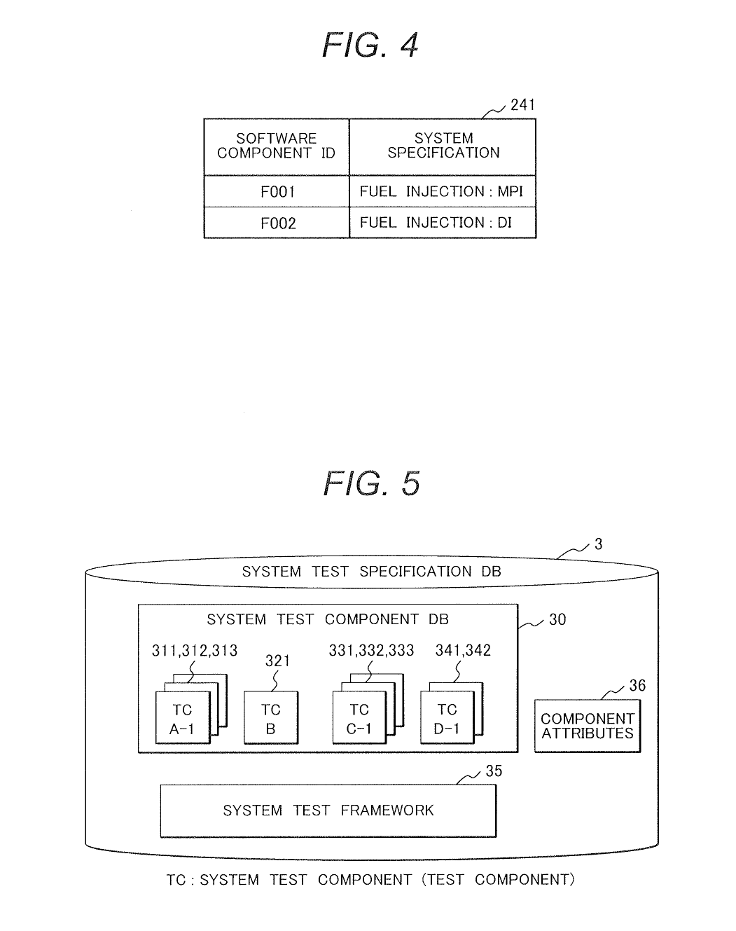

FIG. 4 is an illustration showing a table of a software component ID—system specification correspondence database, which is used to associating the software component ID with the system specification in the system specification integration unit 24.

In the software component ID—system specification correspondence database (e.g. 241), the left side of the table shows software component IDs and the right side shows system specifications corresponding thereto. For example, the table shows that in the case where the software to be tested comprises a software component having software component ID F001, the fuel injection specification is “MPI (multi-port injection)” as a system specification. It also shows that in the case where the software comprises a software component having software component ID F002, the fuel injection specification is “DI (direct injection)” as a system specification.

The system specification integration unit 24 has a system specification converter for associating at least either software component-specific information (ID) or setting parameters with a system specification (e.g. fuel injection: MPI).

FIG. 5 is a block diagram showing an example of a system test specification database. The system test specification stored in the system test specification database 3 has a plurality of system test specification components for defining test patterns and a system test specification framework for defining the execution timing thereof. More specifically, the system test specification database 3 comprises a system test component database 30 for storing system test input/output information as components, a system test framework 35 for controlling the execution sequence and execution timing of system test components, and a component attribute database 36 for storing system test component attribute information.

The system test component database 30 is composed of roughly four kinds of components: system test components 311, 312 and 313 concerning test pattern A corresponding to software component A; a system test component 321 concerning test pattern B corresponding to software component B; system test components 331, 332, and 333 concerning test pattern C corresponding to software component C; and system components 341 and 342 concerning test pattern D to be a reference output (desirable output) of combination software. Each system test component comprises input/output information to software, such as a waveform and a message.

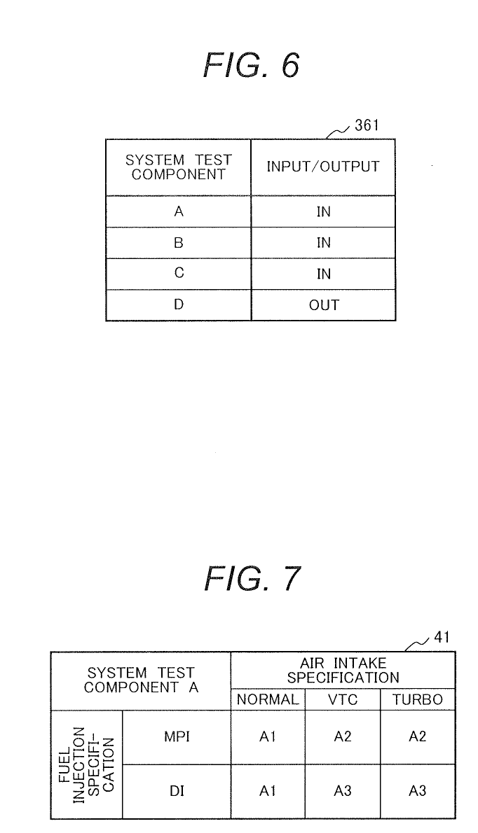

FIG. 6 is an illustration showing a table of a system test component attribute database (e.g. 361) concerning system test component A 31, system test component B 32, system test component C 33, system test component D 34, etc. The table shows system test components on the left side of the table and either input or output to software as attributes of the corresponding software components on the right side. In, FIG. 6, system test component A, system test component B, and system test component C are input patterns, and system test component D is a reference output pattern.

In accordance with the system specification from the system specification integration unit 24, the system test specification setting unit 4 executes a system test component of its data base 30 under the system test framework 35 to change and set the system test specification thereof.

FIG. 7 is an illustration showing a table of a system test component A-setting unit 41 concerning system test component A of the system test specification setting unit 4. The first column and the second column of the table show system specification items concerning fuel injection and system specification items concerning air intake, respectively. For example, the table shows that in the case where the fuel injection specification is “MPI” and the air intake specification is “normal”, system test component A1 (311) is selected for system test component A. It also shows that in the case where the fuel injection specification is “DI” and the air intake specification is “VTC”, system test component A3 (313) is adopted for system test component A.

As shown in FIG. 5, system test component A comprises three variations: system test component A 311, system test component A 312, and system test component A 313. Therefore, there is a need to determine whether to adopt system test component A or not and, in the case of adopting system test component A, to select any one of system test component A 311, system test component A 312, and system test component A 313. Here, the system test component A-setting unit 41 performs determination processing as to which variation of system test component A to select on the basis of the system specification obtained in the software component ID—system specification correspondence database 241.

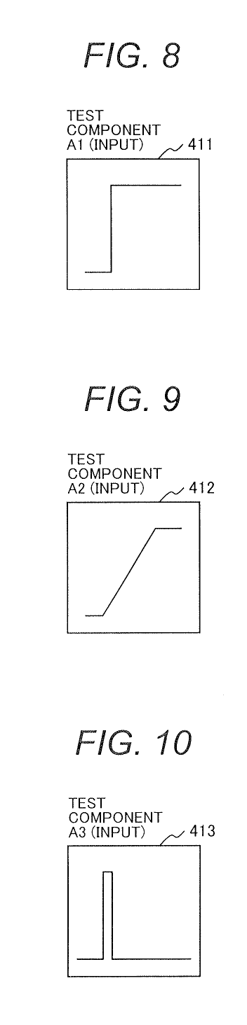

FIG. 8 shows a waveform pattern of system test component A1. The waveform pattern 411 of system test component A1 is a step input.

FIG. 9 shows a waveform pattern of system test component A2. The waveform pattern 412 of system test component A2 is a ramp input.

FIG. 10 shows a waveform pattern of system test component A3. The waveform pattern 413 is an impulse input (square wave input).

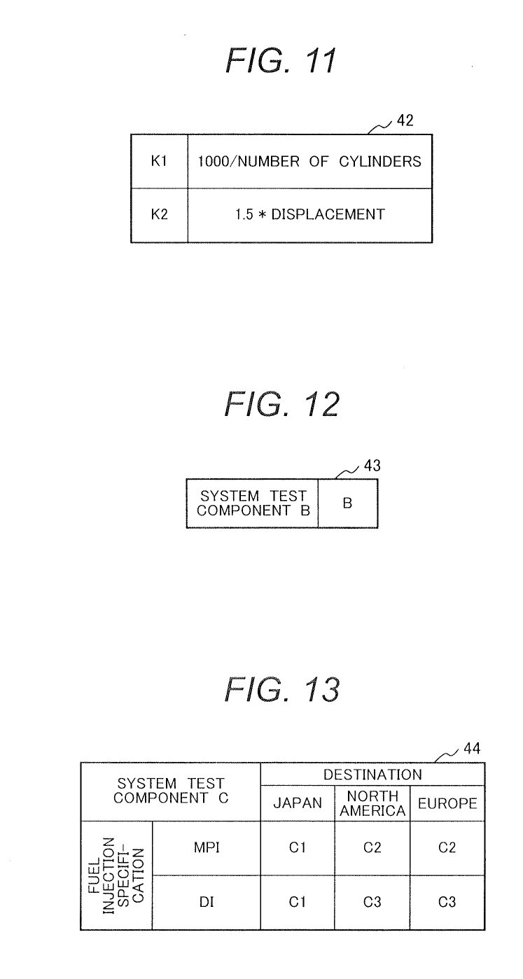

FIG. 11 shows a table of a system test component A-parameter setting unit concerning system test component A of the system test specification setting unit 4. On the left side of the table of the setting unit 42 are common setting parameters (k1 and k2) used by the variations of system test component A (311, 312, and 313), and on the right side of the table are calculation formulas expressing the correspondence between the common parameters and the parameters 61101 and 61102 of software component A (611). The maximum values of the waveform patterns 411, 412, and 413 and the slope of the ramp input of the waveform pattern 412 are set using the calculation formulas for the setting parameters k1 and k2.

For example, described is a case of how to determine the parameters of the waveform pattern of the square waveform input (A3) in FIG. 10. By letting the height and the width (time) of the square wave input be denoted as k2 (1.5×displacement) and k1 (=1000/the number of cylinders) [t] in FIG. 11, respectively, the parameters of the system test component are determined using the setting parameters of the software component.

FIG. 12 shows a system test component B-setting unit 43 concerning system test component B 321 of the system test specification setting unit 4. Since the system test component B 321 has no variations, there is no need to determine a correspondence between the system test component and the system specification, and therefore system test component B 321 is automatically selected.

FIG. 13 shows a table of a system test component A-setting unit 44 concerning system test component C of the system test specification setting unit 4. The first column and the second column of the table show system specification items concerning fuel injection and system specification items concerning destinations, respectively. For example, the table shows that in the case where the fuel injection specification is “MPI” and the destination is “Japan”, system test component C1 (331) is selected for system test component C. It also shows that in the case where the fuel injection specification is “DI” and the destination is “Europe”, system test component C3 (333) is adopted for system test component C.

As shown in FIG. 5, system test component A comprises three variations: system test component C 331, system test component C 332, and system test component C 333. Therefore, there is a need to determine whether to adopt system test component C or not and, in the case of adopting system test component C, to select any one of the three variations.

Here, the system test component C-setting unit 44 performs determination processing as to which variation of system test component C is to be selected on the basis of the system specification obtained in the software component ID—system specification correspondence database 241.

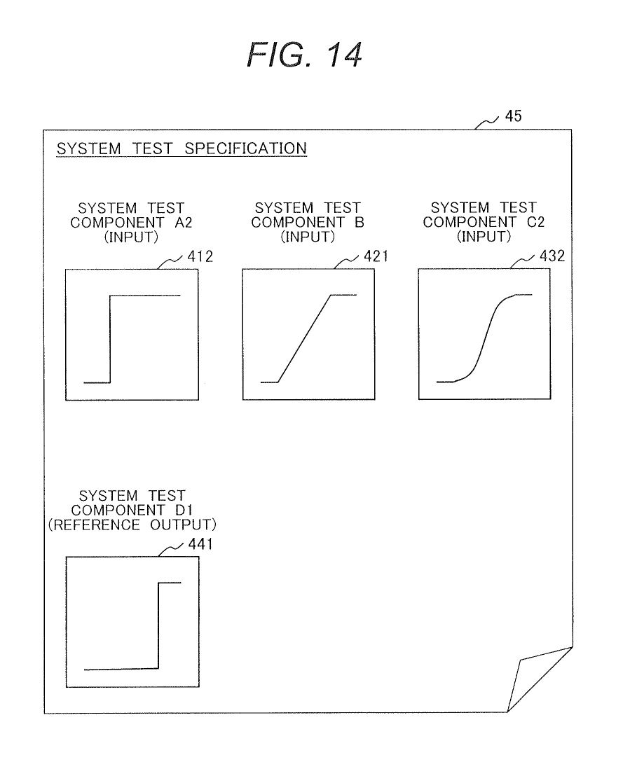

FIG. 14 is an illustration showing a system test specification set by the system specification setting unit.

The system test specification 45 comprises a waveform pattern 412 of system test component A2 (input) 312, a waveform pattern 421 of system test component B (input) 321, a waveform pattern 432 of system test component C1 (input) 331, and a waveform pattern 441 of system test component D1 (reference output) 341.

The structure as described above can generate a system test specification by executing the system test work to select corresponding system test components on the basis of setting information of software components constituting software to be tested.

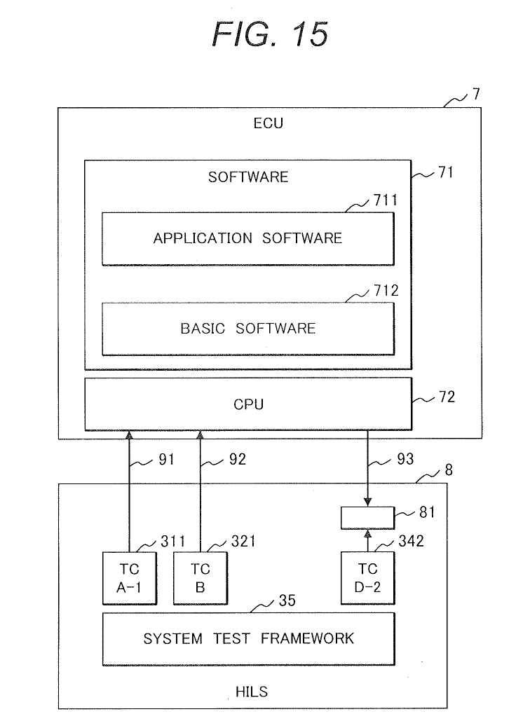

FIG. 15 is a block diagram showing a test environment for built-in software in which a system test specification is used. The test environment comprises an electronic control unit (ECU) 7 having the software built therein and a real-time testing device (Hardware-In-the-Loop Simulator: HILS) 8 where a system test specification is executed.

The ECU 7 comprises software 71 to be tested and a CPU 72 to which external input/output terminals are connected, the CPU 72 executing the software 71. The software 71 comprises basic software 712 for performing input/output processing, etc. in the CPU 72 and application software 711 for performing control processing such as feedback control and sequence control.

The HILS (Hardware in the Loop Simulation) 8 comprises the system test framework 35 and system test components executed thereon: system test component A-1 (311), system test component B (321), and system test component D-2 (342). In the example of FIG. 15, system test component C is not adopted as an input pattern.

The system test framework 35 executes system test component A-1 (311) and system test component B (321) in predetermined timing. System test component A-1 (311) and system test component B (321) compute a test input pattern and generate inputs 91 and 92 such as voltage and current to the ECU 7 using the output function of the HILS 8.

The software 71 performs computation on the basis of the input patterns 91 and 92 and resulting in generation of an output 93 using the CPU 72.

The system test framework 35 executes system test component D2 (342) in predetermined timing, and system test component D2 (342) computes a test output pattern, which is a reference output.

Determination unit 71 compares the output 93 from the CPU 72 with the test output to determine whether it is within a predetermined margin of error or not, thereby determining whether the software 71 is functioning as required. If the determination result is good, the software 71 satisfies the required functions, which means that the operation of the real machine has been verified.

### INDUSTRIAL APPLICABILITY

The present invention can be used for system tests for software comprising a plurality of software components.

### REFERENCE SIGNS LIST

1: software, 11: software component A, 12: software component B, 13: software component C, 2: specification analysis unit, 21: software component specification extraction unit A, 22: software component specification extraction unit B, 23: software component specification extraction unit C, 24: system specification integration unit, 241: software component ID-system specification correspondence database, 3: system test specification database, 30: system test component database, 35: system test framework, 36: component attributes, 361: system test component attribute database, 4: system test specification setting unit, 41: system test component A setting unit, 42: system test component A parameter setting unit, 43: system test component B setting unit, 44: system test component A setting unit concerning system test component C, 5: system test specification output unit, 7: electronic control unit (ECU), 71: software, 72: CPU, 8: real-time testing device (HILS), 81: determination equipment

1. A system test specification generation device that generates a system test specification used for doing a verification operation of built-in software comprising a plurality of software components, on the basis of a functional specification of the built-in software which operates in a state of being built in equipment, the system comprising:
a specification information analysis unit including a plurality of software component specification extraction units for extracting software component specification information from the respective software components, each of the software component specification extraction units corresponding to each of the software components, and a system specification integration unit for integrating the software component specification information to generate a system specification;
a system test specification database for storing a plurality of system test specification components for defining the respective test patterns and a system test specification framework for the respective defining execution timings of the system test specification components, as a reusable system test specification for the built-in software;
a system test specification setting unit for constructing a system test specification by executing the system test specification framework to retrieve test specifications corresponding to each of the software components from the plurality of system test specification components in accordance with the system specification from the specification information analysis unit; and
a system test specification output unit for outputting the system test specification.

2. The system test specification generation device according to claim 1, wherein the software component specification extraction units extract software component-specific information for identifying variations of the software components and software component parameters for setting the software components for a specific product.

3. The system test specification generation device according to claim 2, wherein the system specification integration unit associates at least either the software component-specific information or the software component parameters with a system specification.

4. The system test specification generation device according to claim 3, wherein each of the system test specification components comprises a system test specification input component to be an input to the software and a system test specification assessment component to be a reference output of the software.

5. The system test specification generation device according to claim 4, wherein the system test specification setting unit performs determination processing to select the variations of the system test specification components to be executed from the system test specification framework on the basis of the system specification.

6. The system test specification generation device according to claim 4, wherein the system test specification setting unit performs determination processing to select a correspondence between common parameters set for the variations of the system test specification components and the parameters of the software components on the basis of the system specification.

7. The system test specification generation device according to claim 1, wherein the system test specification stored in the system test specification database is input/output device-operation patterns of the equipment.

8. The system test specification generation device according to claim 1, wherein the built-in software is particularly basic software for operating input/output devices of the equipment, and the system test specification stored in the system test specification database is a combination of input/output device-operation patterns of the equipment and a sample application for executing the basic software.

9. A system test specification generation device that generates a system test specification used for doing a verification operation of built-in software comprising a plurality of software components and having software component-specific information for identifying variations of the software components and software component parameters for setting the software components for a specific product, on the basis of a functional specification of the built-in software which operates in a state of being built in equipment having a sensor and an actuator, the system comprising:
a specification information analysis unit including a plurality of software component specification extraction units for extracting software component specification information from the respective software components, each of the software component specification extraction units corresponding to each of the software components, and a system specification integration unit for associating at least either the software component-specific information or the software component parameters with a system specification and integrating the software component specification information to generate the system specification;
a system test specification database for storing a plurality of system test specification components for defining the respective test patterns and a system test specification framework for the respective defining execution timings of the system test specification components, as a reusable system test specification for the built-in software, each of the system test specification components comprising a system test specification input component to be an input to the software and a system test specification assessment component to be a reference output of the software;
a system test specification setting unit that constructs a system test specification by executing the system test specification framework to retrieve a test specification from the plurality of system test specification components and performing determination processing to select any one of variations of the system test specification components with respect to each of the software components on the basis of the system specification and to select a correspondence between common parameters set for the variations of the system test specification components and the parameters of the software components on the basis of the system specification; and
a system test specification output unit for outputting the system test specification.

10. A testing device comprising an electronic control unit where software is built therein and a real-time testing device for executing a system test specification, the testing device that executes verification operation of the built-in software by giving the system test specification generated by the system test specification generation device according to claim 1 to the electronic control unit, wherein the electronic control unit includes the built-in software to be tested and a CPU that executes the built-in software and is connected to external input/output terminals; and
wherein the real-time testing device comprises the system test specification data base according to claim 1 and a determination device, so that the system test specification generated by the system test specification generation device according to claim 1 is set as the system test specification to be executed on the system test framework, and upon execution of the system test framework, the real-time testing device computes a test input pattern by using a system specification input component and gives the input pattern to the electronic control unit as inputs such as voltage and current;
wherein the built-in software of the electronic control unit performs computations on the basis of the input pattern and generates an output signal;
the system test framework of the real-time testing device executes the system test specification assessment component to compute a test output pattern in predetermined timing; and
the determination equipment compares the output signal of the electronic control unit with the test output pattern to determine whether the output signal is within a predetermined margin of error or not, thereby verifying whether the built-in software is functioning as required.
